(19) United States
(12) Patent Application Publication
(10) Pub. No.: US 2026/0166579 A1
(43) Pub. Date: Jun. 18, 2026

(54) HANDSHOWER INCLUDING A MAGNETIC DOCK PUSH BUTTON

(71) Applicant: Delta Faucet Company, Indianapolis, IN (US)

(72) Inventor: David Lee, Westfield, IN (US)

(21) Appl. No.: 19/402,087

(22) Filed: Nov. 26, 2025

Related U.S. Application Data
(60) Provisional application No. 63/733,676, filed on Dec. 13, 2024.

(51) Int. Cl. B05B 15/62; E03C 1/04

(52) U.S. Cl. CPC B05B 15/62; E03C 1/0408

(57) ABSTRACT

A handshower assembly includes a mount having a body and a magnetic device supported by the body. A handshower includes a housing, a sprayface supported by a front portion of the housing, and a magnetic pushbutton supported by a rear portion of the housing. The magnetic pushbutton is manually actuatable by a user to control a function of the handshower. The handshower is in spaced relation to the mount in an undocked mode. The magnetic pushbutton is magnetically coupled to the magnetic device in a docked mode.

### CROSS-REFERENCE TO RELATED APPLICATION

The present application claims priority to U.S. Provisional Patent Application Ser. No. 63/733,676, filed Dec. 13, 2024, the disclosure of which is expressly incorporation herein by reference.

### BACKGROUND AND SUMMARY OF THE DISCLOSURE

The present invention relates generally to a shower system and, more particularly, to a magnetic coupling for securing a moveable handshower.

As known, a bathing area frequently includes a shower system. Discharging water through apertures in a showerhead of the shower system generates a showering spray of water within the bathing area.

Some conventional shower systems include a handheld showerhead or handshower, which can direct a spray of water separate from a spray of water emitting from a fixed overhead showerhead. Some shower systems may deliver water to the bathing area selectively through the overhead showerhead and/or the handshower.

The handshower may be moveably mounted or docked to another portion of the shower assembly. A user undocks and removes the handshower within the bathing area to manually change the direction and location of the spray of water. Magnetic couplings for docking handshowers are known in the art. The handshower and the other portion of the shower assembly each include a respective magnetic component, and these magnetic components are magnetically attracted to each other. Accordingly, the user may place the magnetic component of the handshower on the magnetic component of the other portion of the shower assembly such that they become magnetically attached to each other, and thus the handshower is docked.

Conventional handshowers are known to include at least one mechanical pushbutton which activates functions of the handshower. For example, the pushbutton may actuate a valve to control which apertures of the handshower discharge water (i.e., are active outlets). For example, a handshower sprayhead may have first apertures on its front face for spraying water in a direction substantially perpendicular to its handle for easily rinsing the user's body. The handshower sprayhead may have second apertures on its distal tip for spraying water in a direction substantially parallel to its handle for easily rinsing a shower wall. A pushbutton on the rear of the handshower handle may be used to control whether water is directed to the first apertures and/or the second apertures.

Pushbuttons typically consist of a pushbutton cover, which is used to actuate a plunger for a pushbutton structure, such as a ramp/tooth structure, or clock spring type structure, for example. The pushbutton cover is depressed and follows the pushbutton switch structure, and typically returns back to its original position by spring bias.

A currently occurring situation is that pushbutton structures used to activate functions occupy roughly the same area as the magnetic docking on the rear side of handshowers. The traditional solution is to offset or space apart the two (i.e., the pushbutton and the magnetic docking) so that they do not interfere with each other, but this may require significant tradeoffs in position optimization for both pushbutton use and magnetic docking position.

The present invention specifically combines the structures of the pushbutton and the magnetic docking so they can physically occupy the same space, thereby eliminating the primary tradeoffs related to function or design. In one illustrative embodiment, the docking structure, or a portion of the docking structure, such as the magnet itself, acts as the pushbutton cover. The handshower may be docked like normal when the pushbutton is not actively being depressed. To activate the pushbutton, the docking structure can be depressed and the pushbutton actuates along the common axis of the docking structure and the pushbutton structure. Thus, the user simply presses the docking structure as a pushbutton, rather than the pushbutton being a dedicated standalone pushbutton.

As a side benefit, it is common to use rear-placed pushbuttons to control water through an upward facing outlet, such as for a cleaning spray. By combining the magnetic docking mechanism with the pushbutton, there is less chance of the pushbutton being inadvertently activated while the handshower is docked, which could lead to the unfortunate result of the ceiling being sprayed.

According to an illustrative embodiment of the present disclosure, a handshower assembly includes a mount having a body and a magnetic device supported by the body. A handshower includes a housing, a sprayface supported by a front portion of the housing, and a magnetic pushbutton supported by a rear portion of the housing. The magnetic pushbutton is manually actuatable by a user to control a function of the handshower. The handshower is in spaced relation to the mount in an undocked mode. The magnetic pushbutton is magnetically coupled to the magnetic device in a docked mode.

According to another illustrative embodiment of the present disclosure, a handshower assembly includes a mount having a body and a magnetic device supported by the body. A handshower includes a housing having a plurality of first apertures to emit a fluid in a first direction. A sprayface is supported by a front portion of the housing. The sprayface has a plurality of second apertures to emit the fluid in a second direction. A magnetic pushbutton is supported by a rear portion of the housing. The magnetic pushbutton is manually actuatable by a user to selectively cause the fluid to be emitted by the first apertures or by the second apertures. The handshower can be manually moved between a docked position in which the magnetic pushbutton is magnetically coupled to the magnetic device, and an undocked position in which the magnetic pushbutton is magnetically decoupled from the magnetic device.

According to yet another illustrative embodiment of the present disclosure, a handshower assembly includes a mount having a body and a first magnetic docking device supported by the body. A handshower includes a housing, a sprayface supported by a front portion of the housing, and a pushbutton supported a rear portion of the housing. The pushbutton is manually actuatable by a user to control a function of the handshower. A second magnetic docking device substantially surrounds the pushbutton. The handshower is in spaced relation to the mount in an undocked mode. The first magnetic docking device is magnetically coupled to the second magnetic docking device in a docked mode.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an illustrative handshower assembly of the present disclosure;

FIG. 2 is a perspective view of the handshower of FIG. 1, shown spraying water in two possible directions;

FIG. 3 is a plan view of another illustrative embodiment of a pushbutton and magnetic docking device of the present disclosure;

FIG. 4a is a fragmentary, side cross-sectional view of the pushbutton and magnetic docking device of FIG. 3, with the pushbutton shown in a non-depressed position;

FIG. 4b is a fragmentary, side cross-sectional view of the pushbutton and magnetic docking device of FIG. 3, with the pushbutton shown in a depressed position;

FIG. 5a is a perspective view of another illustrative pushbutton of the disclosure, shown in a released position;

FIG. 5b is a perspective view of the pushbutton of FIG. 5a, shown in a pressed position;

FIG. 6a is a perspective view of yet another illustrative pushbutton of the disclosure, shown in a released position;

FIG. 6b is a perspective view of the pushbutton of FIG. 6a, shown in a pressed position;

FIG. 7 is a side view of still another illustrative pushbutton of the disclosure, shown moving between a released position and a pressed position (in phantom);

FIG. 8 is a side view of a further illustrative pushbutton of the disclosure, shown moving between a released position and a pressed position (in phantom).

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

The embodiments of the disclosure described herein are not intended to be exhaustive or to limit the disclosure to the precise forms disclosed. Rather, the embodiments described herein enable one skilled in the art to practice the disclosure.

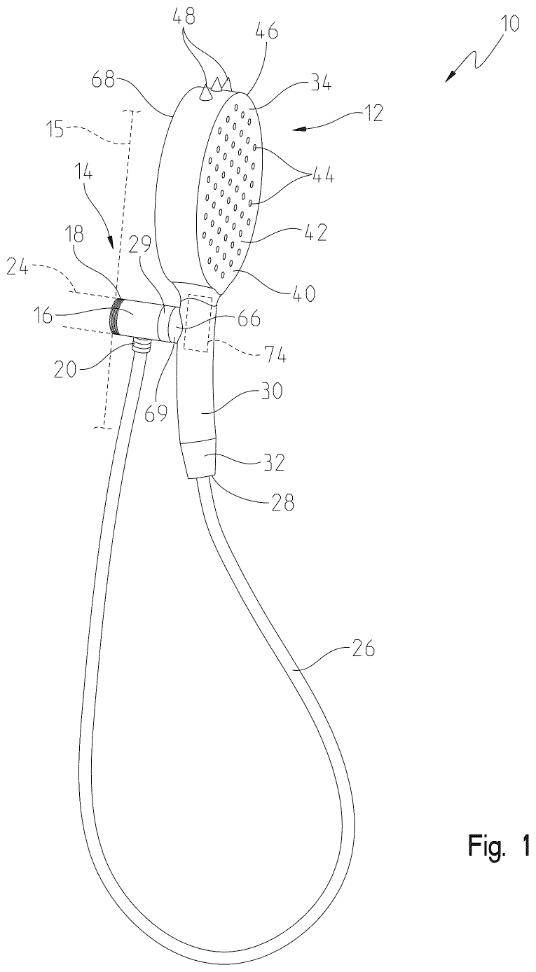

Referring initially to FIG. 1, an illustrative handshower assembly 10 of the present disclosure includes a handheld showerhead or handshower 12 removably coupled (e.g., “docked”) to a mount 14 supported by a vertical shower wall 15. A water supply provides water to the movable handshower 12 illustratively through the mount 14 via a water control valve (not shown). More particularly, the mount 14 illustratively includes a body 16 defining an inlet 18 in fluid communication with an outlet 20. The inlet 18 is illustratively coupled to a conventional shower arm 24, and a flexible hose 26 illustratively couples the outlet 20 to an inlet 28 of the handshower 12.

A magnetically attractive support or seat, illustratively a disc-shaped projection 29, which may be a first magnet, a ferrous metal and/or a ferromagnetic metal, extends outwardly from the mount body 16 opposite the inlet 18. Projection 29 may have other shapes, such as the shape of a washer. It is also possible for the magnetically attractive support or seat to not project outwardly from the mount body 16, but to have an outer surface that is flush with an outer surface of the mount body. In certain illustrative embodiments, the mount 14 may include a fixed showerhead (not shown) for dispensing water and/or a diverter valve (not shown) to selectively control water flow to the handshower 12 and/or the fixed showerhead.

The handshower 12 illustratively includes a housing 30 having a handle 32 operably coupled to a sprayhead 34. The inlet 28 is illustratively defined by the handle 32. A sprayface 40 is illustratively coupled to a front portion 42 of the sprayhead 34 and includes plurality of apertures 44 for dispensing water therefrom.

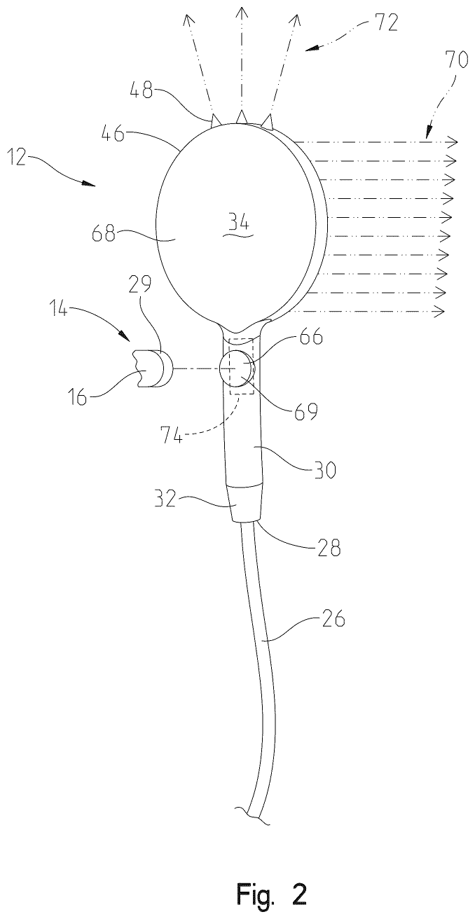

A top, distal end 46 of sprayhead 34 illustratively includes another set of apertures 48 for dispersing water therefrom. As further discussed below with reference to FIG. 2, apertures 48 may spray in directions generally perpendicular to the directions in which apertures 44 spray. In other illustrative embodiments, additional sets of apertures may be formed in other parts of the sprayhead 34, for example in the sprayface 40.

The handshower 12 further illustratively includes a magnetically attractive pushbutton 66 supported by the housing 30 and, more particularly by a rear portion 68 of the handle 30 or the sprayhead 34. Illustratively, some portion (e.g., the cover) of the magnetically attractive pushbutton 66 may be a second magnet 69. Alternatively, the cover of the portion of the magnetically attractive pushbutton 66 may be formed of a metal (e.g., a ferrous or ferromagnetic material).

FIG. 2 shows the handshower 12 of the shower system 10 of FIG. 1 in an undocked mode, where the handshower 12 is in spaced relation to the mount 14. FIG. 2 further shows the handshower 12 spraying water in two possible directions indicated at 70, 72. Illustratively, only one of the two different directional sprays 70, 72 may occur at any one point in time. For example, pushbutton 66 may have two different positions that the user can toggle between by depressing pushbutton 66. In one of the two positions, water is sprayed only from apertures 44 (FIG. 1) on front portion 42 of the sprayhead 34, as indicated at 70. In the other one of the two positions, water is sprayed only from apertures 48 on top end 46 of the sprayhead 34, as indicated at 72. In other illustrative embodiments, water may be simultaneously dispensed from apertures 44 and 48 in directions 70 and 72, respectively.

The pushbutton 66 may control a diverter valve 74 that selectively diverts the water flow to either apertures 44 or apertures 48 (or to any additional apertures formed in the handshower 12). That is, in one of the two positions of the pushbutton 66, the diverter valve 74 diverts the water flow to apertures 44, and in the other one of the two positions of the pushbutton 66, the diverter valve 74 diverts the water flow to apertures 48.

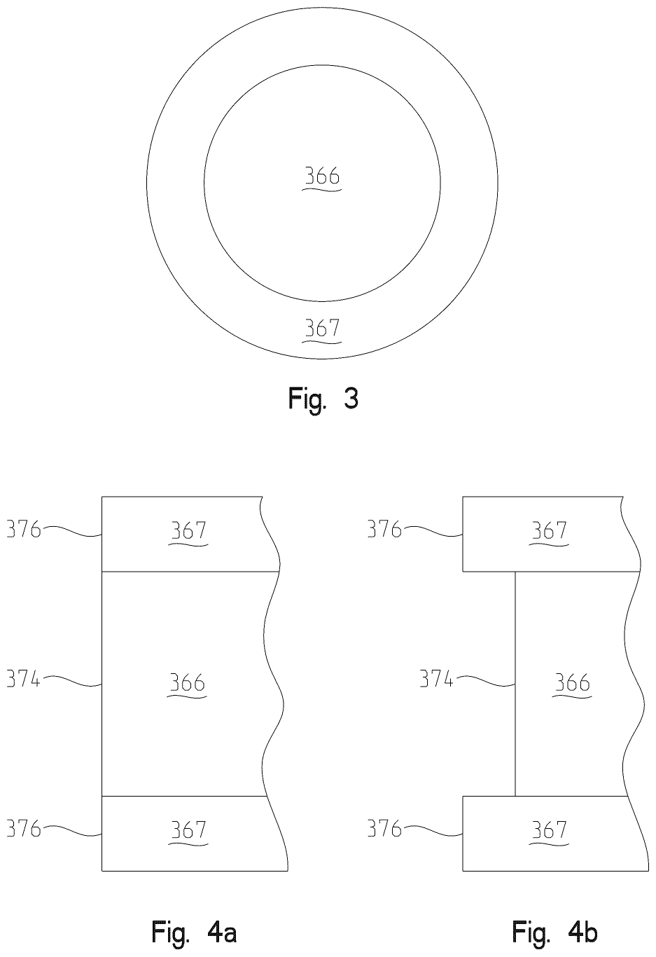

FIG. 3 illustrates another embodiment of a pushbutton 366 and magnetic docking device 367 of the present disclosure. Pushbutton 366 itself is not necessarily magnetic and may not include any magnetic parts. The annular magnetic docking device 367 may be magnetically attracted to a magnetic disc-shaped docking device, which may be in the form of a projection of the mount (not shown), which may have a diameter approximately equal to the diameter of magnetic docking device 367.

FIG. 4a illustrates the pushbutton 366 and magnetic docking device 367 of FIG. 3 with the pushbutton 366 in a non-depressed position. An outer surface 374 of pushbutton 366 is flush with an outer surface 376 of magnetic docking device 367. Thus, the pushbutton 366 does not extend outwardly beyond magnetic docking device 367, even in the non-depressed position, so as not to interfere with the engagement between magnetic docking device 367 and the magnetic projection of the mount.

FIG. 4b illustrates the pushbutton 366 and magnetic docking device 367 in a depressed position. As known in the art, pushbutton 366 may stay in the depressed position after being depressed until being manually depressed again, at which point pushbutton 366 may return to the non-depressed position of FIG. 4a.

FIGS. 3 and 4a-b illustrate an embodiment in which magnetic docking device 367 provides a continuous ring around the pushbutton 366. However, it is to be understood that the disclosure encompasses embodiments in which the magnetic docking device discontinuously surrounds the pushbutton 366, with there being gaps between adjacent ones of a plurality of magnetic elements. The docking device may include as few as two magnetic elements which may be diametrically opposed to each other on opposite sides of the pushbutton.

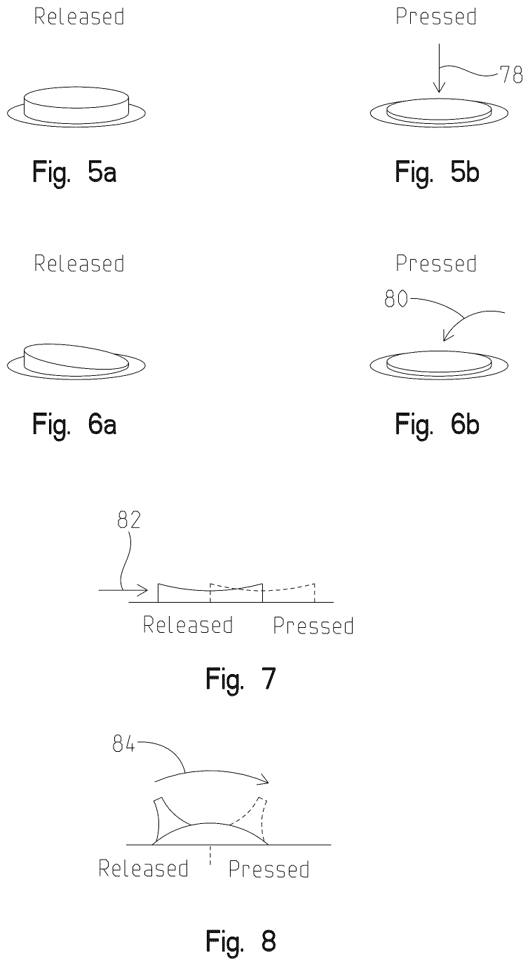

It is to be understood that the term “pushbutton” as used herein is very broad and encompasses all types of switches that can be moved back and forth between two positions. For example, FIG. 5a illustrates another embodiment of a pushbutton of the disclosure in a released position. FIG. 5b illustrates the pushbutton of FIG. 5a in a pressed position after having been pushed down upon in the direction indicated by arrow 78.

FIG. 6a illustrates yet another embodiment of a rocker-type pushbutton of the disclosure in a released position. FIG. 6b illustrates the pushbutton of FIG. 6a in a pressed position after having been pushed down upon in the rotational direction indicated by arrow 80.

FIG. 7 illustrates still another embodiment of a slider-type pushbutton of the disclosure moving from a released position to a pressed position, as indicated by arrow 82.

FIG. 8 illustrates a further embodiment of a rocker-type pushbutton of the disclosure moving from a released position to a pressed position, as indicated by arrow 84.

The invention has been disclosed herein as including a pushbutton to control some function of the handshower, such as direction of water flow, and to also provide a docking mechanism by being magnetically attractive. However, it is also possible for the pushbutton to provide other types of docking mechanisms, such as a hook that enables the handshower to be hung on a complementary rod, hook or recess on the mount.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A handshower assembly comprising:
a mount including a body and a magnetic device supported by the body; and
a handshower including a housing, a sprayface supported by a front portion of the housing, and a magnetic pushbutton supported by a rear portion of the housing, the magnetic pushbutton being manually actuatable by a user to control a function of the handshower;
wherein the handshower is in spaced relation to the mount in an undocked mode; and
wherein the magnetic pushbutton is magnetically coupled to the magnetic device in a docked mode.

2. The handshower assembly of claim 1, wherein the magnetic pushbutton is manually actuatable by a user between a first position and a second position.

3. The handshower assembly of claim 1, wherein the sprayface includes at least one first aperture for emitting a fluid therefrom, the housing including at least one second aperture for emitting the fluid therefrom, the function of the handshower comprising diverting the fluid to the at least one first aperture or to the at least one second aperture.

4. The handshower assembly of claim 3, wherein the at least one first aperture is directed in a first direction, and the at least one second aperture is directed in a second direction different from the first direction.

5. The handshower assembly of claim 1, wherein at least one of the magnetic device and the magnetic pushbutton comprises a magnet.

6. The handshower assembly of claim 5, wherein at least one of the magnetic device and the magnetic pushbutton comprises a ferrous metal material and/or a ferromagnetic material.

7. A handshower assembly comprising:
a mount including a body and a magnetic device supported by the body; and
a handshower including:
a housing having a plurality of first apertures configured to emit a fluid in a first direction;
a sprayface supported by a front portion of the housing, the sprayface having a plurality of second apertures configured to emit the fluid in a second direction; and
a magnetic pushbutton supported by a rear portion of the housing, the magnetic pushbutton being manually actuatable by a user to selectively cause the fluid to be emitted by the first apertures or by the second apertures;
wherein the handshower is configured to be manually moved between:
a docked position in which the magnetic pushbutton is magnetically coupled to the magnetic device; and
an undocked position in which the magnetic pushbutton is magnetically decoupled from the magnetic device.

8. The handshower assembly of claim 7, wherein the magnetic pushbutton is manually actuatable by a user between a first position and a second position.

9. The handshower assembly of claim 7, wherein at least one of the magnetic device and the magnetic pushbutton comprises a magnet.

10. The handshower assembly of claim 9, wherein at least one of the magnetic device and the magnetic pushbutton comprises a ferrous metal material and/or a ferromagnetic material.

11. The handshower assembly of claim 7, wherein the handshower is in spaced relation to the mount in the undocked position.

12. A handshower assembly comprising:
a mount including a body and a first magnetic docking device supported by the body; and
a handshower including:
a housing,
a sprayface supported by a front portion of the housing;
a pushbutton supported by a rear portion of the housing, the pushbutton being manually actuatable by a user to control a function of the handshower; and
a second magnetic docking device substantially surrounding the pushbutton;
wherein the handshower is in spaced relation to the mount in an undocked mode; and
wherein the first magnetic docking device is magnetically coupled to the second magnetic docking device in a docked mode.

13. The handshower assembly of claim 12, wherein the magnetic pushbutton is manually actuatable by a user between a first position and a second position.

14. The handshower assembly of claim 12, wherein the sprayface includes at least one first aperture for emitting a fluid therefrom, the housing including at least one second aperture for emitting the fluid therefrom, the function of the handshower comprising diverting the fluid to the at least one first aperture or to the at least one second aperture.

15. The handshower assembly of claim 14, wherein the at least one first aperture is directed in a first direction, and the at least one second aperture is directed in a second direction different from the first direction.

16. The handshower assembly of claim 12, wherein at least one of the first magnetic docking device and the second magnetic docking device comprises a magnet.

17. The handshower assembly of claim 16, wherein at least one of the first magnetic docking device and the second magnetic docking device comprises a ferrous metal material and/or a ferromagnetic material.

18. The handshower assembly of claim 12, wherein the second magnetic docking device continuously surrounds the pushbutton.

19. The handshower assembly of claim 18, wherein the second magnetic docking device forms a complete loop around the pushbutton.
